(19) United States
(12) Patent Application Publication
(10) Pub. No.: US 2018/0375718 A1
(43) Pub. Date: Dec. 27, 2018

(54) TECHNIQUE FOR TOPOLOGY AWARE NETWORK DEVICE UPGRADES

(71) Applicant: Infinera Corporation, Sunnyvale, CA (US)

(72) Inventors: Madhukar Anand, Fremont, CA (US); Ramesh Subrahmaniam, Fremont, CA (US)

(73) Assignee: Infinera Corporation, Sunnyvale, CA (US)

(21) Appl. No.: 15/788,921

(22) Filed: Oct. 20, 2017

Related U.S. Application Data
(60) Provisional application No. 62/523,593, filed on Jun. 22, 2017.

(51) Int. Cl. H04L 12/24

(52) U.S. Cl. CPC H04L 41/082; H04L 41/12

(57) ABSTRACT

A network device may receive network configuration data indicating a topology of a plurality of network nodes in a network. Based on the received network configuration data, the network device may generate intra-layer and inter-layer upgrade dependency graphs. Based on the intra-layer upgrade dependency graph, the network device may determine an intra-layer upgrade depth for each of the plurality of network nodes. The network device may also determine, based on the inter-layer upgrade dependency graph, an inter-layer upgrade depth for each of the plurality of network nodes. The network device may then determine, based on the intra-layer and inter-layer upgrade depths, an upgrade schedule for the plurality of the network nodes. The upgrade schedule may indicate an order in which the plurality of network nodes is to be upgraded. Based on the upgrade schedule, the network device may transmit at least one instruction to upgrade the plurality of network nodes.

### CROSS REFERENCE TO RELATED APPLICATION

This application claims the benefit of U.S. provisional application No. 62/523,593 filed on Jun. 22, 2017 which is incorporated by reference as if fully set forth herein.

### FIELD OF INVENTION

The disclosed embodiments generally relate to network device upgrades and more particularly, to topology aware network device upgrades.

### BACKGROUND

Software (e.g., firmware, operating system, application, etc.) designed to operate in network devices (e.g., routers, switches, servers, etc.) needs to be upgraded periodically to improve its performance, reliability, and security. Traditionally, networking vendors and operators have adopted technologies such as In-Service Software Upgrade (ISSU) to upgrade network software. An ISSU allows a network operator to update software on a network device without taking that network device offline and thereby disrupting network services. In order to provide such a software upgrade, the ISSU first isolates a network device and then upgrades software of the network device one-by-one. This approach worked when there were few devices in a network, but may no longer be adequate in the wake of Software Defined Networking (SDN) technologies where the network operator has centralized control over the large number of network devices. In a SDN based network, many networking vendors and operators have adopted automated software install and upgrades such as Open Network Install Environment (ONIE) to upgrade software of network devices. In ONIE, a network operator may designate a target device and upgrade its software from a centralized controller. However, it does not consider the target device's relationship with other neighboring devices. For example, in order for the target device to work properly, some neighboring devices must be upgraded first. Furthermore, this technique is limited only to a SDN based network and is not applicable to a non-SDN based network. Thus, it would be desirable to have a method and apparatus providing software upgrades that work with both SDN and non-SDN based networks considering the entire network.

### SUMMARY

A system, method, and/or apparatus are disclosed herein for providing topology aware network device upgrades by a network device. For example, the network device may receive network configuration data from a network management entity. The network configuration data may indicate a topology of a plurality of network nodes in a network. Upon receiving the network configuration data, the network device may generate, based on the network configuration data, an intra-layer upgrade dependency graph and an inter-layer upgrade dependency graph. With the intra-layer upgrade dependency graph, the network device may determine an intra-layer upgrade depth for each of the plurality of network nodes located in the same network layer. The network device may also determine, based on the inter-layer upgrade dependency graph, an inter-layer upgrade depth for each of the plurality of network nodes across network layers. The network device may then determine, based on the intra-layer and inter-layer upgrade depths, an upgrade schedule for the plurality of the network nodes. The upgrade schedule may indicate an order in which the plurality of network nodes is to be upgraded. Based on the upgrade schedule, the network device may transmit at least one instruction to upgrade the plurality of network nodes.

### BRIEF DESCRIPTION OF THE DRAWINGS

A more detailed understanding may be had from the following description, given by way of example in conjunction with the accompanying drawings wherein:

FIG. 1 is a system diagram of an example topology illustrating aspects of topology aware network device upgrades;

FIG. 2 is a system diagram of another example topology illustrating aspects of topology aware network device upgrades;

FIG. 3 is a diagram illustrating an example topology of network organization based on network layers;

FIG. 4 is a diagram illustrating an example intra-layer and inter-layer upgrade dependency graph;

FIG. 5A is a diagram illustrating an example intra-layer subgraph generated from the intra-layer and inter-layer upgrade dependency graph illustrated in FIG. 4;

FIG. 5B is a diagram illustrating an example intra-layer acyclic subgraph generated from the intra-layer subgraph illustrated in FIG. 5A;

FIG. 5C is a diagram illustrating an example intra-layer upgrade subgraph with intra-layer upgrade depth (U) of nodes;

FIG. 6A is a diagram illustrating an example inter-layer subgraph generated from the intra-layer and inter-layer upgrade dependency graph illustrated in FIG. 4;

FIG. 6B is a diagram illustrating an example inter-layer acyclic subgraph generated from the inter-layer subgraph illustrated in FIG. 6A;

FIG. 6C is a diagram illustrating an example inter-layer upgrade subgraph with inter-layer upgrade depth (V) of nodes; and

FIG. 7 is a flow diagram illustrating an example procedure for providing topology aware network device upgrades.

### DETAILED DESCRIPTION

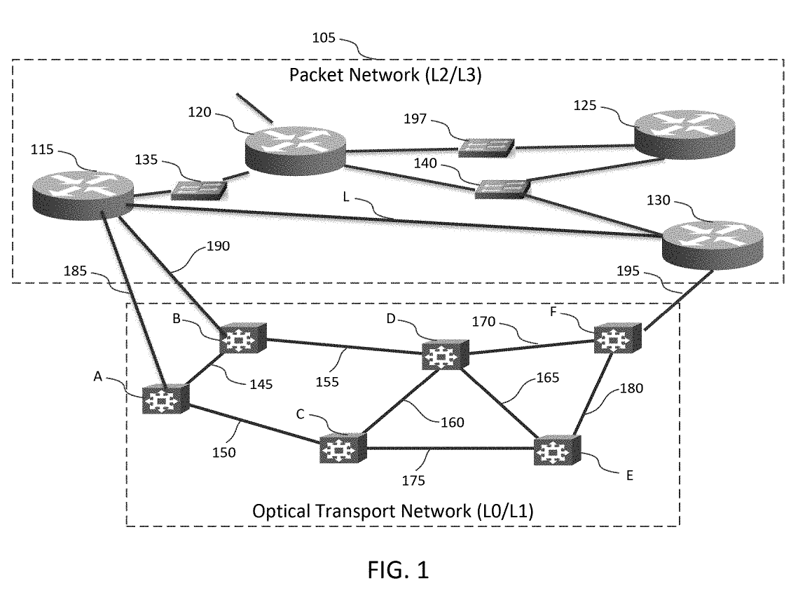

FIG. 1 is a system diagram showing an example topology 100, which illustrates aspects of topology aware network device upgrades. Topology 100 includes a packet network 105 and a transport network 110. Packet network 105 can be described as corresponding generally to a Datalink layer and/or Network layer of topology 100. Transport network 110 can be described as corresponding generally to an Analog Link layer and/or Digital Link layer of topology 100. The Datalink layer and Network layer may be described as Layer 2 (L2) and Layer 3 (L3) of topology 100 respectively. The Analog Link layer and Digital Link layer may also be described as Layer 0 (L0) and Layer 1 (L1) of topology 100 respectively.

Packet network 105 includes packet aware routers 115, 120, 125, 130, 135, and 140, which are capable of packet switching. Packet aware routers are capable of decoding packets for routing. Routers 115, 120, 125, 130, 135, and 140 are in communication within packet network 105 over a number of packet links and nodes. For example, link L connects router 115 with router 130 in the packet domain. In the example of packet network 105, router 115 and router 130 are geographically separated and not directly connected—i.e., link L does not represent a direct or “one-hop” physical connection, but rather, represents a logical connection in the packet domain. At a lower level of abstraction, packets are transported between router 115 and router 130 over transport network 110.

Transport network 110 includes transport nodes A, B, C, D, E and F. It is noted that while transport network 110 is described with respect to optical technology for the sake of illustration, other transport technologies may be used (e.g., wired or radio frequency wireless). Transport nodes A, B, C, D, E and F can include any suitable optical transmission device, such as a fiber-optic repeater, optical receiver/transmitter, optical router, and/or other suitable device for transporting information over transport network 110, and typically do not decode packet headers for routing. Both router 115 and router 130, which do decode packets for routing, are connected to transport network 110, and information can take a number of paths from router 115 to packet aware router 130 through transport network 110.

Routers 115 and 130 are edge devices of the transport network 110 and include circuitry configured to interface the packet network 105 with the transport network 110. Routers 115 and 130 can include, for example, packet-optical gateways (POGs) or packet-transport gateways (e.g., for non-optical transport implementations). Router 115 is in communication with transport node A via transport link 185. Router 115 is also in communication with transport node B via transport link 190. Router 130 is in communication with transport node F via transport link 195. It is noted that router 115 and 130 could be connected to optical nodes A, B, and F via a different kind of link (e.g., non-optical), or routers 115 and/or 130 could be co-located with or could include optical nodes A, B, and F respectively in other implementations.

Transport nodes A, B, C, D, E and F are in communication within transport network 110 over transport links 145, 150, 155, 160, 165, 170, 175, 180, 185, 190, and 195. Transport links 145, 150, 155, 160, 165, 170, 175, 180, 185, 190, and 195 can include any suitable optical medium for transmitting data, such as fiber optic cable. It is noted however that transport links 145, 150, 155, 160, 165, 170, 175, 180, 185, 190, and 195 may include any other suitable transport medium based on the technology of transport network 110 (e.g., electrically conductive cable and/or an air interface).

Viewed from the perspective of packet network 105, packet aware router 115 is only one logical hop away from packet aware router 130, via link L. However packets transmitted from router 115 to router 130 via logical link L are actually transported between router 115 and router 130 over several links of transport network 110. Transport network 110 does not decode headers for routing, and typically the details of transport network 110 are not accessible to routers and other devices in packet network 105.

An application transmitting packets over packet network 105, for example over a path which includes link L from router 115 to router 130, can leverage advertised segments (i.e. paths) to indicate a preference for certain transport characteristics such as latency, bandwidth, reliability, or security characteristics. For example, if a first path (nodes B, D, F via transport links 190, 155, 170, 195) has a particular low latency, and a second path (nodes A, C, E, F via transport links 185, 150, 175, 180, and 195) has a particular high reliability but higher latency, an edge router of the network can push (i.e., append) a label corresponding to the first path onto a packet to indicate a preference for the low latency path, or can push a label corresponding to the second path to indicate a preference for the high reliability path. The edge router may determine the suitable path characteristic using a deployment specific mechanism. For example, the edge router may receive this information from a network device 197, which may include a path computation element (PCE), a network controller or some embedded logic that receives topological updates about the network. A network controller can include a centralized entity configured to receive information about different transport paths and/or segments, and can use this information to create different paths having different characteristics. The network controller has knowledge of the topology of the network and can compute best paths through the network. A PCE can include a device that computes paths with constraints in the network. In either case, network device 197 can be centralized, having a view of the entire network administrative domain over which it has control. The network device 197 (e.g., edge router logic, PCE, or the network controller) may obtain the topological update information by participating in appropriate protocols that flood information about the topology of the network. Packet flooding is a computer network routing algorithm in which every incoming packet is sent through every outgoing link except the link on which it arrived. This label is used by the transport links 145, 150, 155, 160, 165, 170, 175, 180, 185, 190, and 195 to route the packet over the appropriate edges of optical network through transport network 110.

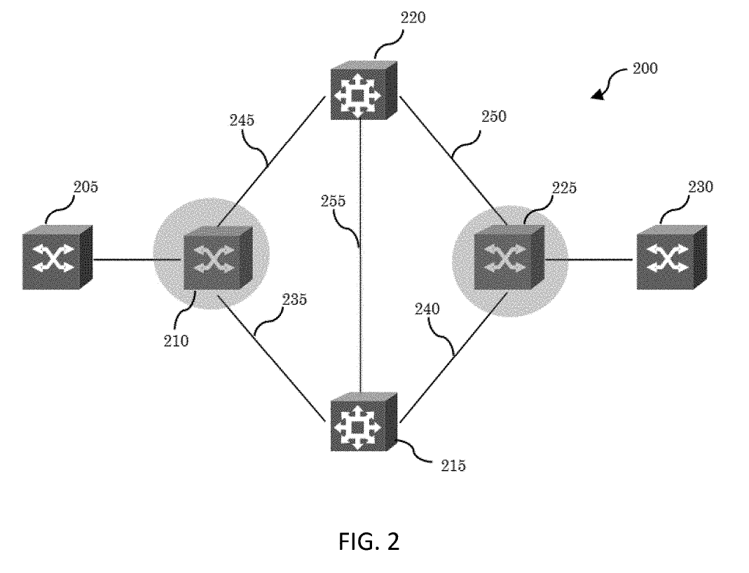

FIG. 2 is a system diagram of another example topology illustrating aspects of topology aware network device upgrades. Topology 200 is similar to topology 100, and includes a packet layer and a transport layer. Topology 200 includes packet nodes 205 and 230, and transport nodes 220 and 215. In topology 200, transport nodes 220 and 215 are optical routers, however other technologies can be used (e.g., wired or radio-frequency wireless). Packet nodes 205 and 230 are packet routers. Topology 200 also includes nodes 210 and 225, which are edge devices of a network which include circuitry configured to interface the packet layer with the transport layer, and which can be described as packet-optical gateways (POGs) or packet-transport gateways. Nodes 210 and 225 thus have features both of packet nodes and transport nodes.

Node 210 has a one-hop packet layer link with node 225 (not shown), however at the transport layer of abstraction, nodes 210 and 225 communicate via transport node 220, transport node 215, or both, over transport links 235, 240, 245, 250, and 255. Such communications may take one of several paths, or edges of optical network, across transport node 220, transport node 215, or both, over transport links 235, 240, 245, 250, and 255. In this example, a first path over transport links 245 and 250 via transport node 220 can be advertised to the packet domain by nodes 210 and 225. A second path over transport links 235 and 240 via transport node 215 can be advertised to the packet domain by nodes 210 and 225. A third path over transport links 245, 255, and 240 via transport nodes 220 and 215 in that order can be advertised to the packet domain by nodes 210 and 225. A fourth path over transport links 235, 255, and 250 via transport nodes 215 and 220 in that order can be advertised to the packet domain by nodes 210 and 225. A packet PCE can include these edges of optical network (i.e. paths) in specifying paths for reaching node 230 from node 205 based on service needs (e.g., a required latency or bandwidth for example) by including them in the appropriate segment lists or label stacks.

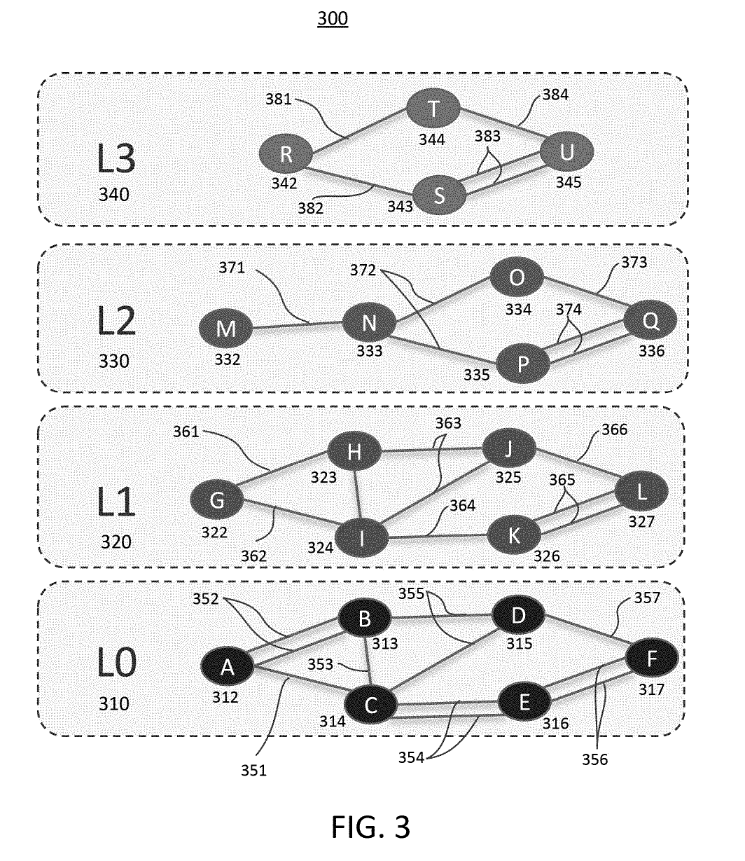

FIG. 3 illustrates an example topology 300 of network organization based on network layers. Topology 300 may comprise multiple network layers 310, 320, 330, 340 and network nodes 312-317, 322-327, 332-336, 342-345 that are interconnected each other via multiple network links 351-357, 361-366, 371-374, 381-384. A network layer 310, 320, 330, 340 serves the network layer above it and is served by the network layer below it. For example, a network layer 310, 320, 330, 340 that provides error-free communications across a network provides the path needed by applications above it, while it calls the next lower layer to send and receive packets that comprise the contents of that path. According to the Open Systems Interconnection model (OSI model), network layers 310, 320, 330, 340 may include seven layers: Physical Layer (Layer 1 320), Data Link Layer (Layer 2 330), Network Layer (Layer 3 340), Transport Layer (Layer 4), Session Layer (Layer 5), Presentation Layer (Layer 6), and Application Layer (Layer 7). However, network layers described herein are not limited to the OSI model. It may further include various network layers such as an Analog Link Layer as L0 310 and Digital Link Layer as L1 320 and combination thereof.

A network node 312-317, 322-327, 332-336, 342-345 is a connection point that can receive, create, store or send data along distributed network routes. Each network node 312-317, 322-327, 332-336, 342-345, whether it is an endpoint for data transmissions or a redistribution point, has either a programmed or engineered capability to recognize, process and forward transmissions to other network nodes. For example, in packet network 105 in FIG. 1, network nodes may include any network devices, such as routers 115, 120, 125, 130, 135, 140, a network device 197, a network controller, and the like. In transport network 110 in FIG. 1, a network node may include any network device, such as a fiber-optic repeater, optical receiver/transmitter, optical router, and/or other suitable device for transporting information over transport network 110.

A network link 351-357, 361-366, 371-374, 381-384 connects two network nodes at the same layer as connected by a horizontal connection in that layer or across different layers as connected by a vertical connection in those layers. For example, in FIG. 1, link L connects router 115 with router 130 in the packet domain by a horizontal connection in the same network layer (i.e. L2/L3 layer). Transport link 185 connects router 115 with transport node A by a vertical connection across two different layers (i.e. L2/L3 and L0/L1). As described above, a network link 351-357, 361-366, 371-374, 381-384 may include a logical connection or a physical connection depending on the network layers where data are transported.

As illustrated in FIG. 3, L0 310 may refer to a physical layer, L1 320 may refer to a data link layer, L2 330 may refer to a network layer, and L3 340 may refer to a transport layer. L0 310 may include network nodes A 312, B 313, C 314, D 315, E 316, and F 317. L1 320 may include network nodes G 322, H 323, I 324, J 325, K 326, and L 327. L2 330 may include network nodes M 332, N 333, O 334, P 335, and Q 336. L3 340 may include network nodes R 342, S 343, T 344, and U 345. Each network node 312-317, 322-327, 332-336, 342-345 may be horizontally connected to one or more adjacent network nodes with one or more links within the same network layer as shown in FIG. 3. For example, a node R 342 may be horizontally connected with a node T 344 and a node S 343 within L3 340. Although it is not shown in FIG. 3, each network node 312-317, 322-327, 332-336, 342-345 may be vertically connected across network layers. For example, a node A 312 in L0 310 may be vertically connected with a node G 322 in L1 320. The node G 322 in L1 320 may be vertically connected with a node M 332 in L2 330. Similarly, the node M 332 in L2 330 may be connected with a node R 342 in L3 340.

Network upgrade dependency may refer to relationship between network nodes 312-317, 322-327, 332-336, 342-345 such that one network node cannot begin or be-completed an upgrade process until the other network node has completed its upgrade process. There may be two types of network upgrade dependency: intra-layer network upgrade dependency and inter-layer network upgrade dependency. Intra-layer network upgrade dependency may refer to dependency of network nodes within the same network layer. For example, in L0 310, a node D 315 depends on a node F 317 for an upgrade. This means that the node D 315 cannot begin its upgrade process until the node F 317 has finished its upgrade process. Similarly, inter-layer network upgrade dependency may refer to dependency of network nodes that are located in different network layers. For example, a node R 342 in L3 340 depends on a node M 332 in L2 330 for an upgrade. This means that the node R 342 cannot initiate its upgrade process until the node M 332 has finished it upgrade process.

In an embodiment, the network upgrade dependency may be extended to more than two network nodes horizontally and/or vertically. In other words, multiple network nodes may form intra-layer and inter-layer network upgrade dependencies at the same time. For example, in L3 340, a node R 342 may depend on a node T 344 and a node S 343 for the L3 intra-layer network upgrade dependency. The same node R 342 in L3 340 may also depend on a node M 332 in L2 330 for the inter-layer network upgrade dependency between different network layers. The network upgrade dependency may also be extended to more than one link. For example, in L2 330, a node M 332 may depend on a node N 333 and the node N 333 may depend on a node O 334 and a node P 335. The node O 334 and node P 335 may depend on a node Q 336 for the intra-layer network upgrade dependency. The same node M 332 may also depend on a node G 322 in L1 320 and the node G 322 may also depend on a node A 312 in L0 310 for the inter-layer network upgrade dependency.

In order to provide seamless network connection in a network, two network nodes may not be upgraded at the same time. For example, a node R 342 and a node T 344 may not be upgraded at the same time. If the nodes R 342 and S 343 are upgraded simultaneously, both nodes R 342 and S 343 may need to be down at the same time and the traffic path from a node U 345 to the node R 342 may be lost. In another example, a node T 344 and a node S 343 may not be upgraded at the same time because if the nodes T 344 and S 343 are upgraded simultaneously, the traffic from the node U 345 to the node R 342 is disconnected. Thus, in network device upgrading, network nodes 312-317, 322-327, 332-336, 342-345 may need to be upgraded one at a time.

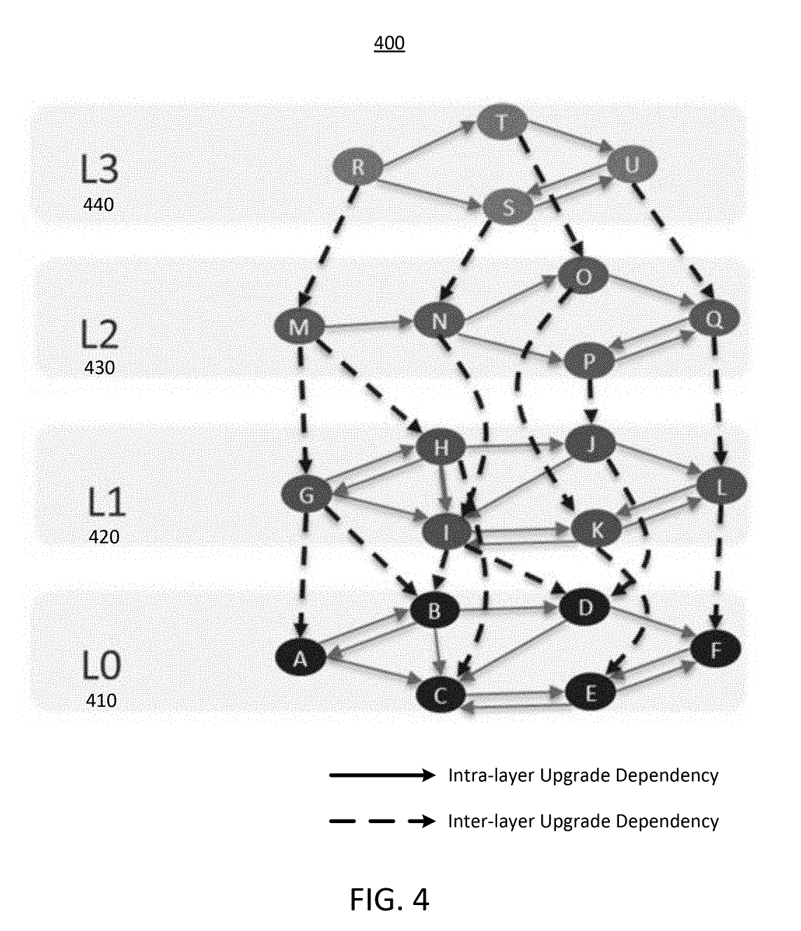

FIG. 4 illustrates an example intra-layer and inter-layer upgrade dependency graph 400 across network layers 410, 420, 430, 440. The intra-layer and inter-layer upgrade dependency graph 400 may be generated by any network node such as A to U based on network configuration data received from a network management entity. For example, a network device that can be a network node A to U may receive network configuration data from a network operator and then may generate an intra-layer and inter-layer upgrade dependency graph 400 based on the network configuration data. In addition to the network configuration data, a network node such as A to U may receive status data from other network nodes or the network management entity to supplement the intra-layer and inter-layer upgrade dependency graph 400. The status data may include information whether the network configuration is effective, time that network upgrade completed, network error messages, or any information related to the status of network nodes. In an embodiment, the status data may include additional information about results of network node upgrades, such as success or failure. In case of upgrade failure, the status data may further include the reason for the failure and time that the failure occurred. As illustrated in FIG. 4, the solid lines between network nodes A to F in L0 410, G to L in L1 420, M to Q in L2 430, and R to U in L3 440 may indicate intra-layer upgrade dependency as described above. Similarly, the dotted lines between network layers 410, 420, 430, 440 may indicate inter-layer upgrade dependency as described above.

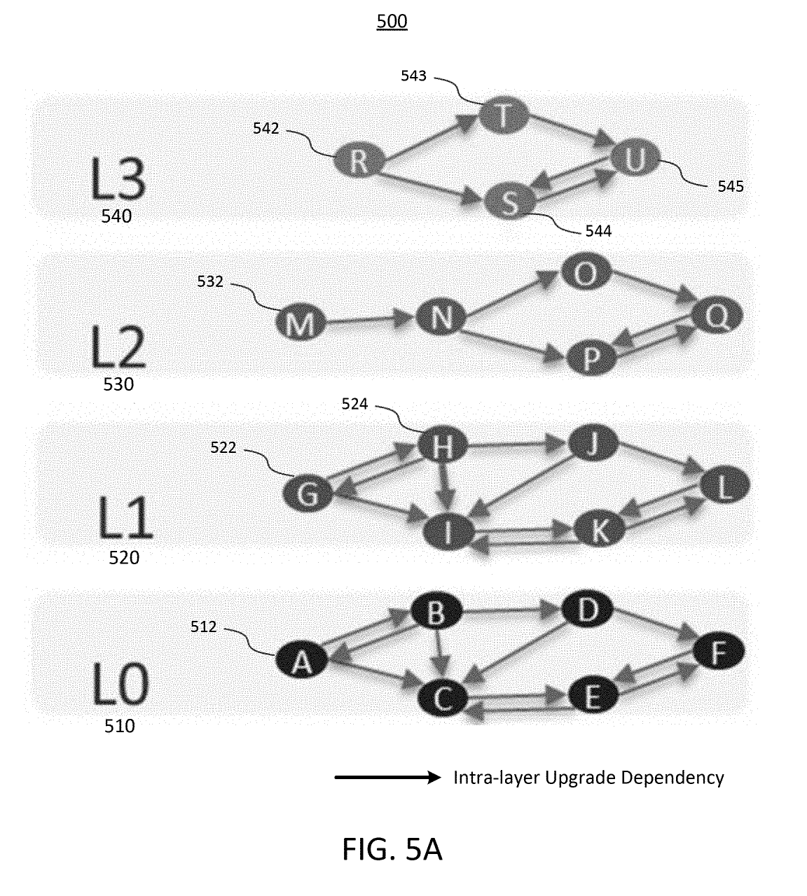

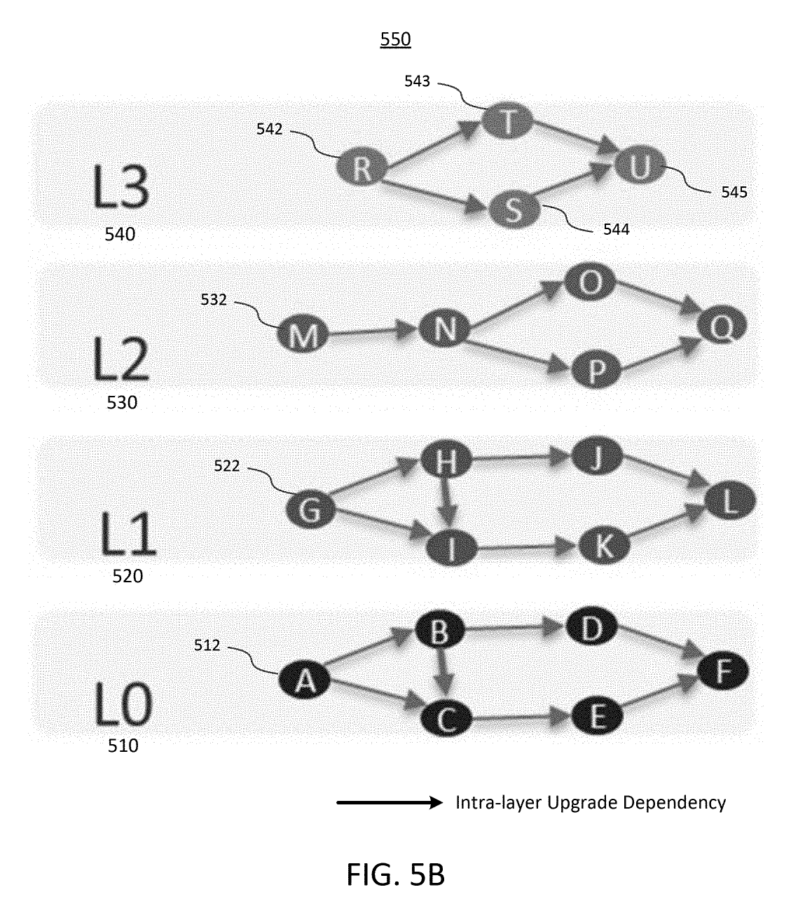

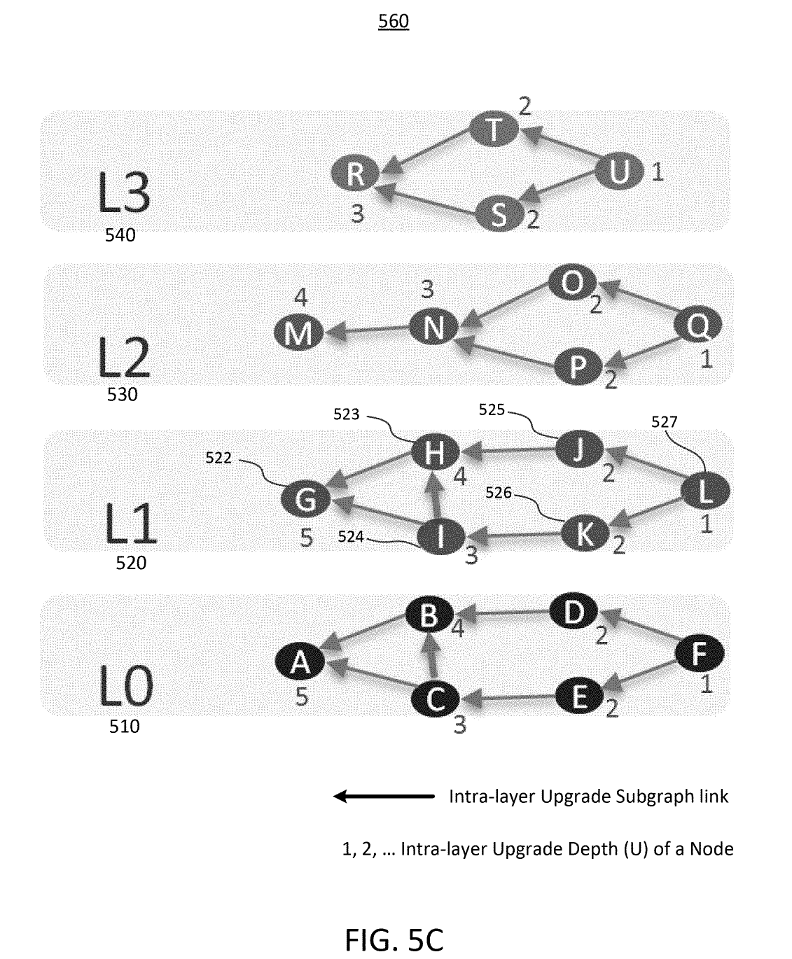

FIG. 5A illustrates an example intra-layer subgraph 500 generated from the intra-layer and inter-layer upgrade dependency graph illustrated in FIG. 4. A network device may generate the intra-layer subgraph 500 by topologically sorting the intra-layer and inter-layer upgrade dependency graph 400. As illustrated in FIG. 5A, the intra-layer subgraph 500 may be divided into multiple subgraphs based on network layers 510, 520, 530, 540. For example, a subgraph includes multiple intra-layer upgrade dependency between network nodes A to F in L0 510.

The intra-layer subgraph 500 may include cyclic or acyclic relationship between network nodes. Cyclic relationship may occur when two or more network nodes depend on each other in their upgrade dependency. For example, as shown in FIG. 5A, a node G 522 and a node H 524 have cyclic relationship for the upgrade. Specifically, the node G 522 depends on the node H 524 and the node H 524 depends on the node G 522 for the upgrade. This means that there is a mutual dependency between nodes G 522 and H 524: the node G 522 can be upgraded before the node H 524 or vice versa. Although it is not shown in FIG. 5A, three or more network nodes may form cyclic relationship for their upgrades. For example, where a node X depends on a node Y, the node Y depends on a node Z, and the node Z depends on the node X, the three nodes X, Y, and Z may form cyclic relationship for their upgrade. Acyclic relationship may be the opposite of the cyclic relationship. This means that two or more nodes may not have cyclic relationship for the upgrade. For example, as illustrated in FIG. 5A, nodes R 542 and T 543 in L3 540 does not form the cyclic relationship because the node R 542 solely depends on the node T 543 for the upgrade.

FIG. 5B illustrates an example intra-layer acyclic subgraph 550 generated from the intra-layer subgraph 500 illustrated in FIG. 5A. For each network layer 510, 520, 530, 540, a network device may generate one or more intra-layer acyclic subgraphs by removing network links that results in cyclic relationship between network nodes. Specifically, the network device may start with the original set of vertices such as nodes A 512, G 522, M 532, R 542 and may add edge node only if they do not result in cyclic relationship. For example, a node R 542 may be designated as the original set of vertices to initiate this process. The network device may add an edge node S 544 into the set because nodes R 542 and S 544 do not form cyclic relationship. However, the node U 545 may not be added directly because, as shown in FIG. 5A, the node S 544 and the node 545 U form cyclic relationship. Thus, one of intra-layer upgrade dependency (i.e. arrow) between the node S 544 and the node U 545 may need to be deleted. Since the node U 545 is the next edge node to be added and the network upgrade dependency from the node U 545 to the node S 544 (i.e. arrow from U to S) creates the cyclic relationship, the network device may determine that the network upgrade dependency from the node U 545 to the node S 544 (i.e. arrow from U to S) needs to be deleted. After all the remaining network nodes are examined and cyclic relationship between the network nodes are removed, the result may be the maximal intra-layer acyclic subgraphs 550 for each network layer 510, 520, 530, 540.

FIG. 5C illustrates an example intra-layer upgrade subgraph 560 with intra-layer upgrade depth (U) of nodes. For each network layer 510, 520, 530, 540, a network device may generate one or more intra-layer upgrade subgraphs 560 based on following two steps: (1) assigning an intra-layer upgrade depth (U) for every network node; and (2) reversing all the network links between the network nodes. The intra-layer upgrade depth (U) may refer to an order in which network nodes within a network layer 510, 520, 530, 540 are to be upgraded. For example, in L1 layer 520, a node L 527 has an intra-layer upgrade depth of 1, and a node J 525 has an intra-layer upgrade depth of 2. This means that the node L 527 needs to be upgraded before the node J 525 is upgraded. In other words, software/firmware in the node J 525 depends on software/firmware in the node L 527 to work properly. Each network node in a network layer 510, 520, 530, 540 may be assigned to its intra-layer upgrade depth (U) based on sorted order values of the network nodes. For example, as illustrated in FIG. 5C, a network node L 527 is the first node that needs to be upgraded in L1 520 layer. Thus, the intra-layer upgrade dependency for the node L 527 is 1. Network nodes J 525 and K 526 are the second nodes to be upgraded after the node L 527 is upgraded. Thus, the intra-layer upgrade dependency for the nodes J 525 and K 526 is 2. A network node I 524 is the third node to be upgraded and a network node H 523 is the fourth node to be upgraded in L1 520. Thus, the intra-layer upgrade dependency for the node I 524 and the node H 523 are 3 and 4, respectively. A network node G 522 is the last node to be upgraded. Thus, the intra-layer upgrade dependency for the node G 522, which was the original vertices that the intra-layer upgrade dependency was started from, is 5.

As described above, the intra-layer upgrade depth (U) may be determined by a network device based on its sorted order value. For example, a following equation (1) may be used to compute the intra-layer upgrade depth (U) for each node in each layer 510, 520, 530, 540:

sᵢⱼ:Uᵢⱼ=max sⱼ−sᵢⱼ+1 Equation (1)

where sᵢⱼ a sorted order value for a node i with a layer j, Uᵢⱼ is an intra-layer upgrade depth for a node i with a layer j, and max sⱼ is the maximum value of intra-layer upgrade depth for the layer j. The sorted order value may be the order of intra-layer upgrade dependency between network nodes illustrated in the intra-layer acyclic subgraph 550 of FIG. 5B. For example, in L1 520, the sorted order value (S_{G2}) of a node G 522 is 1 because the node G 522 was the first node included in the original set of vertices to generate the intra-layer acyclic subgraph 550 illustrated in FIG. 5B. In addition, the value of max s₁ for the node G 522 is 5 because 5 is the maximum value of intra-layer upgrade depth in the layer L1 520 layer. Thus, the intra-layer upgrade depth for node G 522 in the layer L1 520 (U_{G1}) is 5 based on the equation (1). (e.g., U_{G1}=5−1+1).

In another example, in L1 520, the sorted order value (S_{H2}) of a node H 523 is 2 because the node H 523 was the second node added in the set of vertices to generate the intra-layer acyclic subgraph 550 in FIG. 5B. The value of max s₁ for the node H 523 is still 5 because 5 is the maximum value of intra-layer upgrade depth in the layer L1 520. Thus, the intra-layer upgrade depth for node H 523 in the layer L1 520 (U_{H1}) is 4 based on the equation (1). (e.g., U_{H1}=5−2+1). After all the intra-layer upgrade depth for the remaining network nodes for each layer are assigned, a network device, based on the order of the intra-layer upgrade depth, may reverse the direction of all the links in the intra-layer acyclic subgraph 550, thereby creating the intra-layer upgrade subgraph 560. This reversed network link of the intra-layer acyclic subgraph 550 may be called as an intra-layer upgrade subgraph link. The intra-layer upgrade subgraph link may indicate a horizontal order of upgrade for network nodes in the network layers 510, 520, 530, 540.

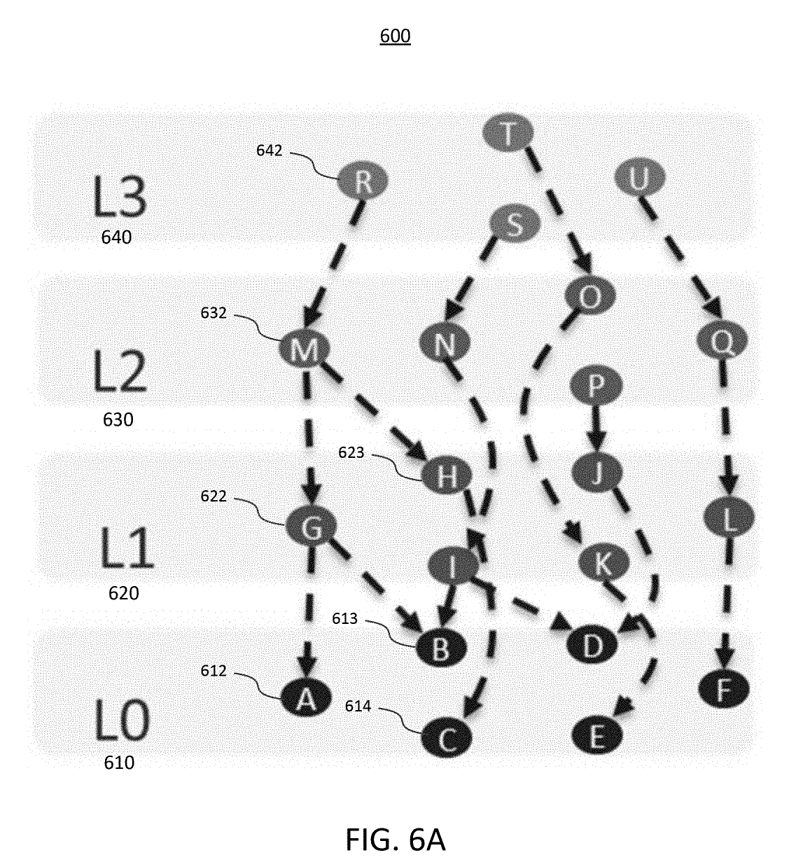

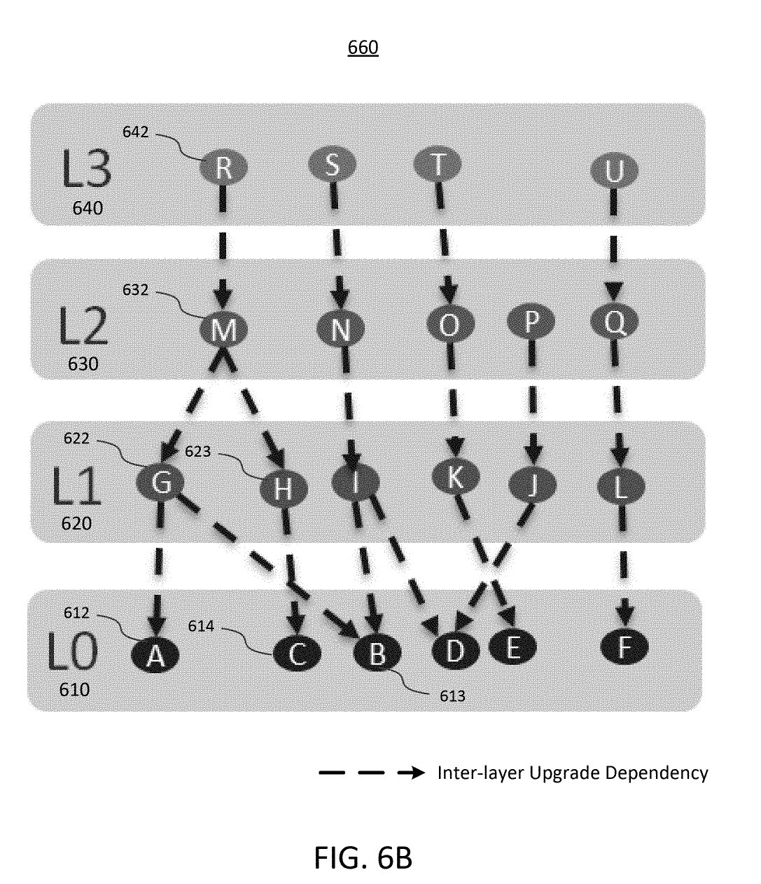

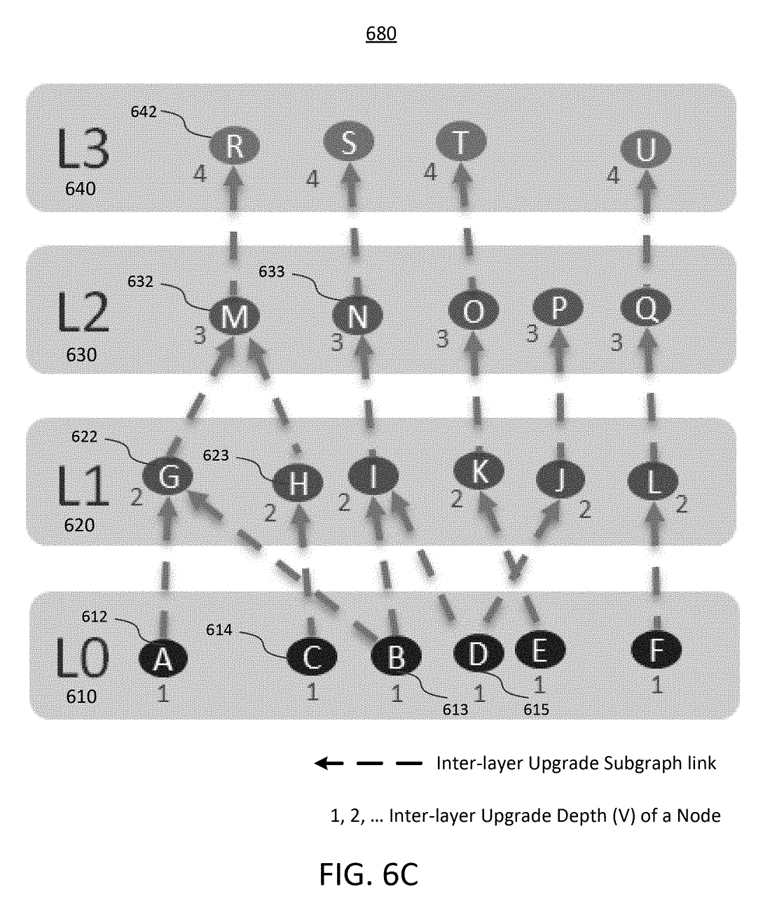

FIG. 6A illustrates an example inter-layer subgraph 600 generated from the intra-layer and inter-layer upgrade dependency graph 400 illustrated in FIG. 4. As shown in FIG. 6A, an inter-layer subgraph 600 may include upgrade dependency of network nodes across multiple network layers 610, 620, 630, 640. Unlike the intra-layer subgraph 500 in FIG. 5A, network nodes in the inter-layer dependency subgraph 600 have acyclic relationship due to the structuring of network layering. This means that network nodes in a higher layer may depend on network nodes in lower layers. For example, as shown in FIG. 6A, a network node R 642 in L3 640 layer depends on a network node M 632 in L2 630 layer for the upgrade. The network node M 632 depends on network node G 622 and H 623 in L1 620 layer. Similarly, the network node G 622 depend on network nodes A 612 and B 613 in L0 610 layer and the network node H 623 depends on a network node C 614 in L0 610 layer for the upgrades. Thus, a network device may not need to determine acyclic relationship in the inter-layer subgraph 600.

FIG. 6B illustrates an example inter-layer acyclic subgraph 660 generated from the inter-layer subgraph 600 illustrated in FIG. 6A. As described above, because the inter-layer dependency subgraph 600 is acyclic in itself, a network device may generate one or more inter-layer acyclic subgraphs 660 by topologically sorting the inter-layer dependency subgraph 600 for each network layers 610, 620, 630, 640. For example, starting from a root node R 642, the network device may sort the inter-layer dependency subgraph 600 to create an inter-layer acyclic subgraph from the node R 642 to nodes A 612, B 613, and C 614. Specifically, a network node R 642 in L3 640 depends on a node M 632 in L2 630. The node M 632 may depend on nodes G 622 and H 623 in L1 620. The nodes G 622 and H 623 may depend on nodes A 612, B 613 and C 614 in L0 610. Thus, the network device may form an inter-layer acyclic subgraph (i.e. R-M-G, H-A, B, C) and assign this inter-layer acyclic subgraph as a first inter-layer acyclic subgraph (i.e. subgraph 1). There may be j number of inter-layer acyclic subgraphs (e.g., subgraph 1, 2, . . . , j) based on numbers of root nodes. Once all of the inter-layer acyclic subgraphs 660 are generated for all the roots nodes, an inter-layer upgrade depth (V) may be determined by the network device for each node in the network layers 610, 620, 630, 640.

FIG. 6C illustrates an example inter-layer upgrade subgraph 680 with inter-layer upgrade depth (V) of nodes. Similar to the intra-layer upgrade depth (U), the inter-layer upgrade depth (V) may refer to an order in which network nodes are to be upgraded across network layers 610, 620, 630, 640. For example, a node A 612 in L0 layer 610 has an inter-layer upgrade depth of 1, and a node G 622 in L1 layer 620 has an inter-layer upgrade depth of 2. This means that the node A 612 needs to be upgraded before the node G 622 is upgraded. In other words, software/firmware in the node A 612 depends on software/firmware in the node G 622 to work properly. The inter-layer upgrade depth (V) may be determined by a network device based on its sorted order value. For example, a following equation (2) may be used to compute the inter-layer upgrade depth (V) for each node in each inter-layer acyclic subgraph:

sᵢⱼ:Vᵢⱼ=max sⱼ−sᵢⱼ+1 Equation (2)

where sᵢⱼ is a sorted order value for a node i in an inter-layer acyclic subgraph j, Vᵢⱼ is an inter-layer upgrade depth (V) for a node i in an inter-layer acyclic subgraph j, and max sⱼ is the maximum value of sorted order in an inter-layer acyclic subgraph j. The sorted order value may be the order of dependency between network nodes across the network layers 610, 620, 630, 640 in an inter-layer acyclic subgraph. For example, for the first inter-layer acyclic subgraph (i.e. subgraph 1 of nodes R-M-G, H-A, B, C), the sorted order value (S_{R1}) of a node R 642 is 1 because the node R 642 is the first node on which other nodes M 632, G 622, H 623, A 612, B 613, C 614 depend on. Similarly, the sorted order values of nodes M 632, G 622, H 623, A 612, B 613, and C 614 are 2, 3, 3, 4, 4, and 4, respectively. The value of max si for the first inter-layer acyclic subgraph (i.e. subgraph 1) is 4 because 4 is the largest number of sort order value in the first inter-layer acyclic subgraph. Thus, based on the sorted order value S_{R1} and max s₁, the inter-layer upgrade depth for node R (V_{R1}) may be computed as 4 following the equation (2). (e.g., V_{R1}=4−1+1).

In another example, for the second inter-layer acyclic subgraph (i.e. j=2), the sorted order value (S_{N2}) of a node N 633 is 2 because the node N 633 is in the second inter-layer acyclic subgraph (i.e. subgraph 2). The value of max s₂ is 4 because 4 is the largest number of sorted order value in the second inter-layer acyclic subgraph. (Here, nodes B 613 and D 615 have the largest sorted order values of 4.) Thus, based on the sorted order value (S_{N2}) and max s₂, the inter-layer upgrade depth for node N 633 (V_{N2}) may be computed as 3. (e.g., V_{N2}=4−2+1). After calculating all the remaining inter-layer upgrade depths for all the network nodes, the network device may assign inter-layer upgrade depths (Vs) to all the network nodes as shown in FIG. 6C. Once the inter-layer upgrade depths (Vs) are assigned, the network device, based on the inter-layer upgrade depth, may reverse the direction of all the links to create inter-layer upgrade subgraph link as shown in FIG. 6C. The inter-layer upgrade subgraph link may indicate a vertical order of upgrade for network nodes across the network layers 610, 620, 630, 640.

Once the intra-layer and inter-layer upgrade depths are determined for all the network nodes, a network device may determine an overall upgrade schedule for all network components/nodes based on the intra-layer and inter-layer upgrade depths. The following equation (3) may be used to determine the overall upgrade schedule:

CurrentUpgradeSet=NodesUG(1)∩NodesVG(1)

While CurrentUpgradeSet≠φ

For all n ε CurrentUpgradeSet

UpgradeIfDependencyMet n

UpgradedSet=UpgradedSet U n;

CurrentUpgradeSet=CurrentUpgradeSet/{n}

For all n ε UpgradedSet

u=IntraLayerUpgradeDepth(n);

v=InterLayerUpgradeDepth(n);

CurrentUpgradeSet=CurrentUpgradeSet U NodesUG(u+1) U NodesVG(v+1) Equation (3)

where NodesUG is a function that takes an intra-layer upgrade depth as input and returns all the nodes in an intra-layer upgrade subgraph 560 (i.e. a graph UG) that correspond to that level of intra-layer upgrade depth. NodesVG is a function that takes an inter-layer upgrade depth (i.e. a graph VG) and returns all the nodes in an inter-layer upgrade subgraph graph 680 that correspond to that level of intra-layer upgrade depth. UpgradeIfDependencyMet is a function that returns true if all underlying upgrade dependencies are met, and returns false otherwise. Specifically, the UpgradeIfDependencyMet function returns true if a network node has no dependency on any other network nodes or other network nodes on which the network node depends are already upgraded. IntraLayerUpgradeDepth(n) or InterLayerUpgradeDepth(n) is a function that takes a node as input in the inter-layer or intra-layer upgrade subgraphs 560, 680 and returns the intra-layer or inter-layer upgrade depth of the selected node n.

The upgrade schedule determined by Equation (3) may refer to an upgrade order of network nodes. As an example, the upgrade schedule for network nodes illustrated in FIGS. 5 and 6, may be initiated from the node F. It is because the node F has the first intra-layer and inter-layer upgrade depths (i.e. 1). As shown in the equation (3), at first step, the CurrentUpgradeSet is initially empty. But after evaluating the NodesUG(1) ∩ NodesVG(1) function, the node F is added into the CurrentUpgradeSet. As second step, since the CurrentUpgradeSet is not empty, the UpgradeIfDependencyMet function is performed for the node F. Since the node F has no dependency on other network nodes, the UpgradeIfDependencyMet function returns true for the node F.

At third step, the node F is simply added into UpgradedSet (i.e. UpgradedSet=UpgradedSet U node F). Then the node F is deleted from the CurrentUpgradeSet (i.e. CurrentUpgradeSet=CurrentUpgradeSet/{node F}). Now the UpgradedSet includes the node F as its element, but the CurrentUpgradeSet does not include the node F and it is empty again. In an embodiment, the network device may transmit an instruction to upgrade the node F before the node F is deleted from CurrentUpgradeSet.

At fourth step, intra-layer and inter-layer upgrade depths are computed for the node F. Since the returned values of depth u and v are both one (1), at fifth step, NodeUG(2) returns nodes D and E, and NodeVG(2) returns a node L. It should be noted that the selected nodes by NodeUG(u+1) and NodeVG(v+1) are all neighbor nodes to the node at the previous step. Here, the nodes D, E, L are added into the CurrentUpgradeSet (i.e. CurrentUpgradeSet=CurrentUpgradeSet U NodesUG(u+1) U NodesVG(v+1)).

After the CurrentUpgradeSet is updated with the nodes D, E, and L, the network device may repeat the above process for the nodes D, E, and L until all the remaining network nodes are upgraded. The following Table 1 shows an example result of upgrade schedule based on the Equation (3):

TABLE 1

| Steps | Upgraded Nodes |
|---|---|
| 1 | F |
| 2 | D, E, L |
| 3 | C, J, K, Q |
| 4 | B, D, I, O, P, U |
| 5 | A, H, N, S, T |
| 6 | G, M, R |

In an embodiment, a network device may evaluate upgrade metrics such as upgrade time or upgrade path based on the upgrade schedule generated by the Equation (3). Specifically, while generating intra-layer and inter-layer acyclic subgraphs 550, 660, many different subgraphs may be created depending on which acyclic links are removed or which paths are selected. This means that there may exist many different upgrade schedules (i.e. upgrade orders) based on different subgraphs. Each of the different upgrade schedules may include different characteristics (i.e. upgrade metrics) in terms of the upgrade time or length of the upgrade path. With these different upgrade metrics, the network device may simulate each of the upgrade schedules for all the network nodes and find an optimal upgrade schedule. Such an optimal upgrade schedule may include the shortest upgrade time, the shortest upgrade path, or the like. If the upgrade metrics are not satisfied, the network device may pick a different subgraph (i.e. different set of links from the original graph) to create a different upgrade schedule. In another embodiment, if no schedule meets the criteria for the optimal upgrade schedule, the network device may pick the best upgrade schedule that is close to the optical upgrade metrics.

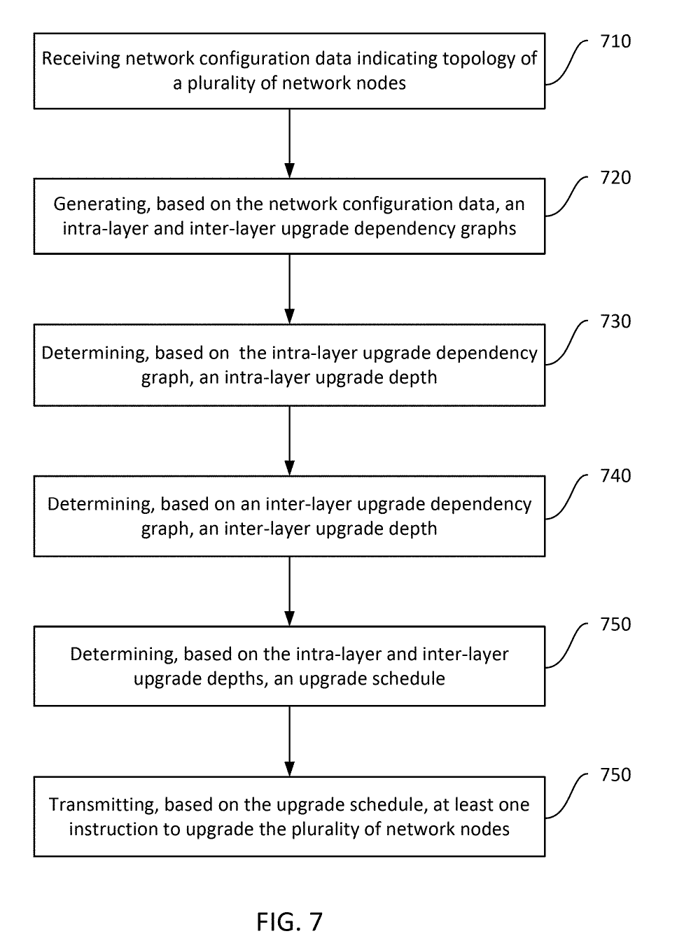

FIG. 7 illustrates an example procedure for providing topology aware network device upgrades. For example, at step 710, a network device may receive, from a network management entity, network configuration data that indicates topology of multiple network nodes in a network. The network device that provides topology aware network device upgrades may be any type of network node in the network. Examples of the network device may include network interfaces, repeaters, hubs, bridges, switches, routers, modems, or the like. The network device may be any type of network node that can receive and/or transmit network data within the network. The network management entity may have a view of the entire network administrative domain over which it has control. The network management entity may provide network configuration data and status information to the network device via wired or wireless connections between the network device and the network management entity. Examples of the network management entity may include a network operator, a network controller, or the like. The network configuration data may include topology information of network nodes in the entire network. The status data may include information about the validity of network configuration, upgrade status of network nodes, upgrade time of network nodes, upgrade error messages, or the like. The network where the topology aware network device is provided may include any type of wired or wireless network with any type of network protocols. Examples of the network may include Personal Area Network (PAN), Local Area Network (LAN), Metropolitan Area Network (MAN), Wide Area Network (WAN), Software-defined Network (SDN), non-SDN, Software-defined mobile networking (SDMN), Software-defined Wide Area Network (SD-WAN), Software-defined Local Area Network (SD-LAN), centralized control network, de-centralized control network or the like. Furthermore, network data center that is used to allow various network nodes to communicate among each other and with other data centers via fiber optic links may interconnects these networks and intra-data center networks.

Upon receiving the network configuration data, at step 720, the network device may generate an intra-layer upgrade dependency graph and an inter-layer upgrade dependency graph based on the received network configuration data. The intra-layer upgrade dependency graph may indicate upgrade dependency between multiple network nodes within a network layer. The inter-layer upgrade dependency graph may indicate upgrade dependency between multiple network nodes across two or more network layers. At step 730, the network device may determine, based on the intra-layer upgrade dependency graph, an intra-layer upgrade depth for each of the multiple network nodes. In order to determine the intra-layer upgrade depth, the network device may generate, from the intra-layer upgrade dependency graph, an intra-layer acyclic subgraph. The intra-layer acyclic subgraph may be generated by removing network links between network nodes that result in a cyclic relationship for the upgrade. Once the intra-layer upgrade dependency graphs are determined, the network device may assign the intra-layer upgrade depth for each of the multiple network nodes in each of the network layers. As described above, the intra-layer upgrade depth may indicate an upgrade order of the multiple network nodes within a network layer.

Similarly, at step 740, the network device may determine, based on an inter-layer upgrade dependency graph, an inter-layer upgrade depth for each of the multiple network nodes. Since the inter-layer upgrade dependency graph itself is acyclic, the network device may generate, from the inter-layer upgrade dependency graph, an inter-layer acyclic subgraph by topologically sorting the inter-layer upgrade dependency graph. The network device may then assign the inter-layer upgrade depth for each of the multiple of network nodes across multiple network layers. The inter-layer upgrade depth may indicate an upgrade order of the multiple network nodes across the multiple network layers.

With the intra-layer and inter-layer upgrade depths, at step 750, the network device may determine an upgrade schedule for the multiple network nodes. The upgrade schedule may indicate an upgrade order of network nodes in the network. The upgrade schedule may be in the form of a set that includes collection of network nodes based on the upgrade order. The upgrade schedule may be any type of data structure that includes collection of the ordered network nodes for the upgrade. In order to determine the upgrade schedule, the network device may select a first set of network nodes among the multiple network nodes. The selected network nodes of the first set may have the same intra-layer upgrade depth and inter-layer upgrade depth. For example, a node F where its intra-layer and inter-layer upgrade depths are one (1) may be included in the first set of network nodes to be upgraded. If nodes D and E are neighbor nodes to the node F within the same layer and their intra-layer upgrade depths are two (2), the node D and E may be included in the second set of network nodes to be upgraded. If a node L is a neighbor node to the node F and its inter-layer upgrade depth is 2, the node L may be included in the second set of network nodes to be upgraded. Upon determining the set of network nodes to be upgraded, at step 750, the network device may transmit upgrade instructions to each of the network nodes in the selected set.

In an embodiment, when the network device selects a network node to be included in an upgrade set, the network device may consider whether the dependency of the network node is met. For example, for the first set of network nodes, the network device may determine that the dependency of the network nodes is met when the network node in the first set does not depend on any network node. For the second set of network nodes, the network device may determine that the dependency of the network nodes is met when the network node in the second set depends on the network nodes in the first set and the network nodes in the first set are successfully upgraded.

In another embodiment, the network device may evaluate upgrade metrics such as time to upgrade the entire network based on an upgrade schedule. For example, the network device may generate, from intra-layer and inter-layer upgrade dependency graphs, multiple intra-layer and inter-layer acyclic subgraphs. Each of the intra-layer and inter-layer acyclic subgraphs may result in different upgrade schedules that are associated with different upgrade metrics. For example, one upgrade schedule that are generated from first intra-layer and inter-layer acyclic subgraph may have a shorter upgrade path than the other upgrade schedule that are generated from second intra-layer and inter-layer acyclic subgraph. The network device may simulate these different upgrade schedules and may find an optimal upgrade schedule. The optimal upgrade schedule may indicate the shortest time to upgrade the entire network or the shortest path to upgrade the entire network. In yet another embodiment, if no schedule meets the criteria for the optimal upgrade schedule, the network device may select the best available upgrade schedule which is close to the optical upgrade metrics.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method comprising:
determining, for each of a plurality of network nodes, an intra-layer upgrade depth and an inter-layer upgrade depth;
determining, based on the determined intra-layer upgrade depths and the determined inter-layer upgrade depths, an upgrade schedule indicative of an order in which the plurality of network nodes are to be upgraded; and
transmitting at least one instruction to upgrade the plurality of network nodes based on the upgrade schedule.

2. The method of claim 1, further comprising:
receiving network configuration data indicative of a topology of the plurality of network nodes in a network; and
generating, based on the network configuration data, an upgrade dependency information indicative of upgrade relationship between the plurality of network nodes.

3. The method of claim 2, further comprising:
generating, based on the upgrade dependency information, an intra-layer upgrade dependency graph and an inter-layer upgrade dependency graph;
determining, based on the intra-layer upgrade dependency graph, the intra-layer upgrade depth for each of the plurality of network nodes; and
determining, based on the inter-layer upgrade dependency graph, the inter-layer upgrade depth for each of the plurality of network nodes.

4. The method of claim 3, further comprising:
generating, from the intra-layer upgrade dependency graph, an intra-layer acyclic subgraph by removing at least one network link that results in a cyclic relationship between the plurality of network nodes located in a network layer; and
assigning the intra-layer upgrade depth to each of the plurality of network nodes.

5. The method of claim 4, wherein the intra-layer upgrade depth indicates an order in which the plurality of network nodes are to be upgraded within the network layer.

6. The method of claim 3, further comprising:
generating, from the inter-layer upgrade dependency graph, an inter-layer acyclic subgraph by topologically sorting the inter-layer upgrade dependency graph; and
assigning the inter-layer upgrade depth to each of the plurality of network nodes across multiple network layers.

7. The method of claim 6, wherein the inter-layer upgrade depth indicates an order in which the plurality of network nodes are to be upgraded across the multiple network layers.

8. The method of claim 1, further comprising:
determining a first network node among the plurality of network nodes, the first network node having upgrade depths that correspond to a first intra-layer upgrade depth and a first inter-layer upgrade depth; and
upgrading the first network node on a condition that a dependency of the first network node is met.

9. The method of claim 8, wherein the dependency of the first network node is met when the first network node does not depend on any network node in a network and a dependency of a second network node is met when the second network node depends on the first network node and the first network node is upgraded.

10. The method of claim 1, further comprising:
generating a first upgrade metric based on a first upgrade schedule;
generating a second upgrade metric based on a second upgrade schedule;
comparing the first upgrade metric with the second upgrade metric; and
upgrading a plurality of network nodes based on the first upgrade schedule on a condition that the first upgrade metric is faster than the second upgrade metrics,
wherein the first and second upgrade metrics indicate time to upgrade all of the plurality of network nodes.

11. The method of claim 10, further comprising:
generating, from the intra-layer upgrade dependency graph, a second intra-layer acyclic subgraph;
generating, from the inter-layer upgrade dependency graph, a second inter-layer acyclic subgraph;
determining, based on the second intra-layer acyclic subgraph, a second intra-layer upgrade depth;
determining, based on the second inter-layer acyclic subgraph, a second inter-layer upgrade depth; and
determining, based on the second intra-layer and inter-layer upgrade depths, the second upgrade schedule.

12. A network device comprising:
a processor configured to:
determine, for each of a plurality of network nodes, an intra-layer upgrade depth and inter-layer upgrade depth;
determine, based on the determined intra-layer upgrade depths and the determined inter-layer upgrade depths, an upgrade schedule indicative of an order in which the plurality of network nodes are to be upgraded; and
a transmitter configured to transmit at least one instruction to upgrade the plurality of network nodes based on the upgrade schedule.

13. The network device of claim 12, further comprising:
a receiver configured to receive network configuration data indicative of a topology of the plurality of network nodes in a network; and
the processor further configured to generate, based on the network configuration data, an upgrade dependency information indicative of upgrade relationship between the plurality of network nodes.

14. The network device of claim 13, wherein the processor is further configured to:
generate, based on the upgrade dependency information, an intra-layer upgrade dependency graph and an inter-layer upgrade dependency graph;
determine, based on the intra-layer upgrade dependency graph, the intra-layer upgrade depth for each of the plurality of network nodes; and
determine, based on the inter-layer upgrade dependency graph, the inter-layer upgrade depth for each of the plurality of network nodes.

15. The network device of claim 14, wherein the processor is further configured to:
generate, from the intra-layer upgrade dependency graph, an intra-layer acyclic subgraph by removing at least one network link that results in a cyclic relationship between the plurality of network nodes located in a network layer; and
assign the intra-layer upgrade depth to each of the plurality of network nodes,
wherein the intra-layer upgrade depth indicates an order in which the plurality of network nodes are to be upgraded within a network layer.

16. The network device of claim 14, wherein the processor is further configured to:
generate, from the inter-layer upgrade dependency graph, an inter-layer acyclic subgraph by topologically sorting the inter-layer upgrade dependency graph; and
assign the inter-layer upgrade depth to each of the plurality of network nodes across multiple network layers,
wherein the inter-layer upgrade depth indicates an order in which the plurality of network nodes are to be upgraded across the multiple network layers.

17. The network device of claim 12, the processor is further configured to:
determine a first network node among the plurality of network nodes, the first network node having upgrade depths that corresponds to a first intra-layer upgrade depth and a first inter-layer upgrade depth; and
upgrade the first network node on a condition that a dependency of the first network node is met.

18. The network device of claim 17, wherein the dependency of the first network node is met when the first network node does not depend on any network node in the network and a dependency of a second network node is met when the second network node depends on the first network node and the first network node is upgraded.

19. The network device of claim 12, wherein the process is further configured to:
generate a first upgrade metric based on a first upgrade schedule;
generate a second upgrade metric based on a second upgrade schedule;
compare the first upgrade metric with the second upgrade metric; and
upgrade a plurality of network nodes based on the first upgrade schedule on a condition that the first upgrade metric is faster than the second upgrade metrics,
wherein the first and second upgrade metrics indicate time to upgrade all of the plurality of network nodes.

20. The network device of claim 19, wherein the processor is further configured to:
generate, from the intra-layer upgrade dependency graph, a second intra-layer acyclic subgraph;
generate, from the inter-layer upgrade dependency graph, a second inter-layer acyclic subgraph;
determine, based on the second intra-layer acyclic subgraph, a second intra-layer upgrade depth;
determine, based on the second inter-layer acyclic subgraph, a second inter-layer upgrade depth; and
determine, based on the second intra-layer and inter-layer upgrade depths, the second upgrade schedule.
